(19) United States
(12) Patent Application Publication
(10) Pub. No.: US 2021/0337274 A1
(43) Pub. Date: Oct. 28, 2021

(54) ARTIFICIAL INTELLIGENCE APPARATUS AND METHOD FOR PROVIDING VISUAL INFORMATION

(71) Applicant: LG ELECTRONICS INC., Seoul (KR)

(72) Inventor: Wonyoung LEE, Seoul (KR)

(73) Assignee: LG ELECTRONICS INC., Seoul (KR)

(21) Appl. No.: 16/487,651

(22) PCT Filed: May 2, 2019
(86) PCT No.: PCT/KR2019/005273

§ 371 Date: Aug. 21, 2019

(51) Int. Cl. H04N 21/466; H04N 21/439; H04N 21/422; H04N 21/482; H04N 21/45; H04N 21/81; H04N 21/478; G10L 15/26

(52) U.S. Cl. CPC H04N 21/4665; H04N 21/4394; H04N 21/42203; G10L 15/26; H04N 21/4532; H04N 21/8113; H04N 21/47815; H04N 21/4821

(57) ABSTRACT

Provided is an artificial intelligence apparatus for providing visual information including a display unit, and a processor that obtains sound data, determine a type of content included in the obtained sound data, generate related information corresponding to the content based on the content and the type of the content, and output, on the display unit, the generated related information.

### BACKGROUND

### 1. Field

The present invention relates to an artificial intelligence apparatus and a method for providing visual information. Specifically, the present invention relates to an artificial intelligence apparatus and a method for providing information related to obtained sound data as an image.

### 2. Related Art

Artificial intelligence, which means that computers may imitate a human intelligence, is a field of computer engineering and information technology that studies a method for allowing the computers to think, learn, self-develop, and the like that may be performed by the human intelligence.

Further, the artificial intelligence does not exist by itself, but directly or indirectly related to other fields of the computer science. Particularly in the modern age, attempts to introduce artificial intelligence elements in various fields of the information technology and to utilize the artificial intelligence elements in solving problems in the field are being actively carried out. Recently, such artificial intelligence technology has been utilized for an artificial intelligence speaker, and the artificial intelligence speaker functions as a voice assistant or a hub for an artificial intelligence platform.

However, current artificial intelligence speakers may only interact as the voice and a response is also provided only as sound. Thus, there is a limit to information that may be provided as a response by the artificial intelligence speakers.

### SUMMARY

A purpose of the present invention is to provide an artificial intelligence apparatus and a method that have a display unit and provide related information corresponding to obtained sound as an image.

Further, another purpose of the present invention is to provide an artificial intelligence apparatus and a method that obtain program information of a TV or radio and provide related information corresponding to the program as an image.

Further, still another purpose of the present invention is to provide an artificial intelligence apparatus and a method that output information preferred by a user among related information preferentially.

In a first aspect, there is provided an artificial intelligence apparatus and a method for obtaining sound data, determining a type of content included in the obtained sound data, generating related information corresponding to the content based on the content and the type of the content, and outputting, on a display unit, the generated related information.

Further, in a second aspect, there is provided an artificial intelligence apparatus and a method for determining whether the sound data is output from a TV or a radio, obtaining program information of the TV or the radio when it is determined that the sound data is a sound output from the TV or the radio, and generating the related information using the obtained program information.

Further, in a third aspect, there is provided an artificial intelligence apparatus and a method for determining a user preference category among the at least one category, and preferentially outputting a page corresponding to the user preference category when outputting the related information, wherein the user preference category is a category having a highest preference score, where the preference score is higher as a user output request frequency is higher and is lower as a time duration between a current time and a user output request timing is longer.

According to various embodiments of the present invention, in addition to a response to speech interaction of the user, various related information corresponding to the content output from the TV, the radio, or the like may be provided as the image.

Further, according to various embodiments of the present invention, the various related information corresponding to the currently playing TV or radio may be provided using the program information of the TV or radio.

Further, according to various embodiments of the present invention, the information determined to be preferred by the user among various related information of the content may be preferentially output, thereby increasing the satisfaction of acquiring the information of the user.

### BRIEF DESCRIPTION OF DRAWINGS

FIG. 1 is a block diagram illustrating a configuration of a terminal according to an embodiment of the present invention.

FIG. 2 is a block diagram illustrating a configuration of a learning device of an artificial neural network according to an embodiment of the present invention.

FIG. 3 is a block diagram illustrating an artificial intelligence system according to an embodiment of the present invention.

FIG. 4 is a flowchart illustrating a method for providing visual information according to an embodiment of the present invention.

FIG. 5 is a flowchart illustrating an example of a step S403 of determining a type of content included in sound data illustrated in FIG. 4.

FIG. 6 is a view illustrating an artificial intelligence system according to an embodiment of the present invention.

FIGS. 7 to 9 are views illustrating examples of providing visual information by an artificial intelligence apparatus according to an embodiment of the present invention.

FIGS. 10 and 11 are views illustrating examples of providing visual information by an artificial intelligence apparatus according to an embodiment of the present invention.

FIG. 12 is a view illustrating an example of providing visual information by an artificial intelligence apparatus according to an embodiment of the present invention.

FIG. 13 is a view illustrating an example of providing visual information by an artificial intelligence apparatus according to an embodiment of the present invention.

FIGS. 14 and 15 are views illustrating examples of providing visual information by an artificial intelligence apparatus according to an embodiment of the present invention.

### DETAILED DESCRIPTIONS

Hereinafter, embodiments of the present invention are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present invention is not limited thereto. It should be understood that all of variations, equivalents or substitutes contained in the concept and technical scope of the present invention are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

Artificial intelligence (AI) is one field of computer engineering and information technology for studying a method of enabling a computer to perform thinking, learning, and self-development that can be performed by human intelligence and may denote that a computer imitates an intelligent action of a human.

Moreover, AI is directly/indirectly associated with the other field of computer engineering without being individually provided. Particularly, at present, in various fields of information technology, an attempt to introduce AI components and use the AI components in solving a problem of a corresponding field is being actively done.

Machine learning is one field of AI and is a research field which enables a computer to perform learning without an explicit program.

In detail, machine learning may be technology which studies and establishes a system for performing learning based on experiential data, performing prediction, and autonomously enhancing performance and algorithms relevant thereto. Algorithms of machine learning may use a method which establishes a specific model for obtaining prediction or decision on the basis of input data, rather than a method of executing program instructions which are strictly predefined.

The term “machine learning” may be referred to as “machine learning”.

In machine learning, a number of machine learning algorithms for classifying data have been developed. Decision tree, Bayesian network, support vector machine (SVM), and artificial neural network (ANN) are representative examples of the machine learning algorithms.

The decision tree is an analysis method of performing classification and prediction by schematizing a decision rule into a tree structure.

The Bayesian network is a model where a probabilistic relationship (conditional independence) between a plurality of variables is expressed as a graph structure. The Bayesian network is suitable for data mining based on unsupervised learning.

The SVM is a model of supervised learning for pattern recognition and data analysis and is mainly used for classification and regression.

The ANN is a model which implements the operation principle of biological neuron and a connection relationship between neurons and is an information processing system where a plurality of neurons called nodes or processing elements are connected to one another in the form of a layer structure.

The ANN is a model used for machine learning and is a statistical learning algorithm inspired from a neural network (for example, brains in a central nervous system of animals) of biology in machine learning and cognitive science.

In detail, the ANN may denote all models where an artificial neuron (a node) of a network which is formed through a connection of synapses varies a connection strength of synapses through learning, thereby obtaining an ability to solve problems.

The term “ANN” may be referred to as “neural network”.

The ANN may include a plurality of layers, and each of the plurality of layers may include a plurality of neurons. Also, the ANN may include a synapse connecting a neuron to another neuron.

The ANN may be generally defined by the following factors: (1) a connection pattern between neurons of a different layer; (2) a learning process of updating a weight of a connection; and (3) an activation function for generating an output value from a weighted sum of inputs received from a previous layer.

The ANN may include network models such as a deep neural network (DNN), a recurrent neural network (RNN), a bidirectional recurrent deep neural network (BRDNN), a multilayer perceptron (MLP), and a convolutional neural network (CNN), but is not limited thereto.

In this specification, the term “layer” may be referred to as “layer”.

The ANN may be categorized into single layer neural networks and multilayer neural networks, based on the number of layers.

General single layer neural networks is configured with an input layer and an output layer.

Moreover, general multilayer neural networks is configured with an input layer, at least one hidden layer, and an output layer.

The input layer is a layer which receives external data, and the number of neurons of the input layer is the same the number of input variables, and the hidden layer is located between the input layer and the output layer and receives a signal from the input layer to extract a characteristic from the received signal and may transfer the extracted characteristic to the output layer. The output layer receives a signal from the hidden layer and outputs an output value based on the received signal. An input signal between neurons may be multiplied by each connection strength (weight), and values obtained through the multiplication may be summated. When the sum is greater than a threshold value of a neuron, the neuron may be activated and may output an output value obtained through an activation function.

The DNN including a plurality of hidden layers between an input layer and an output layer may be a representative ANN which implements deep learning which is a kind of machine learning technology.

The term “deep learning” may be referred to as “deep learning”.

The ANN may be learned by using training data. Here, training may denote a process of determining a parameter of the ANN, for achieving purposes such as classifying, regressing, or clustering input data. A representative example of a parameter of the ANN may include a weight assigned to a synapse or a bias applied to a neuron.

An ANN learned based on training data may classify or cluster input data, based on a pattern of the input data.

In this specification, an ANN learned based on training data may be referred to as a trained model.

Next, a learning method of an ANN will be described.

The learning method of the ANN may be largely classified into supervised learning, unsupervised learning, semi-supervised learning, and reinforcement learning.

The supervised learning may be a method of machine learning for analogizing one function from training data.

Moreover, in analogized functions, a function of outputting continual values may be referred to as regression, and a function of predicting and outputting a class of an input vector may be referred to as classification.

In the supervised learning, an ANN may be learned in a state where a label of training data is assigned.

Here, the label may denote a right answer (or a result value) to be inferred by an ANN when training data is input to the ANN.

In this specification, a right answer (or a result value) to be inferred by an ANN when training data is input to the ANN may be referred to as a label or labeling data.

Moreover, in this specification, a process of assigning a label to training data for learning of an ANN may be referred to as a process which labels labeling data to training data.

In this case, training data and a label corresponding to the training data may configure one training set and may be inputted to an ANN in the form of training sets.

Training data may represent a plurality of features, and a label being labeled to training data may denote that the label is assigned to a feature represented by the training data. In this case, the training data may represent a feature of an input object as a vector type.

An ANN may analogize a function corresponding to an association relationship between training data and labeling data by using the training data and the labeling data. Also, a parameter of the ANN may be determined (optimized) through evaluating the analogized function.

The unsupervised learning is a kind of machine learning, and in this case, a label may not be assigned to training data.

In detail, the unsupervised learning may be a learning method of training an ANN so as to detect a pattern from training data itself and classify the training data, rather than to detect an association relationship between the training data and a label corresponding to the training data.

Examples of the unsupervised learning may include clustering and independent component analysis.

In this specification, the term “clustering” may be referred to as “clustering”.

Examples of an ANN using the unsupervised learning may include a generative adversarial network (GAN) and an autoencoder (AE).

The GAN is a method of improving performance through competition between two different AIs called a generator and a discriminator.

In this case, the generator is a model for creating new data and generates new data, based on original data.

Moreover, the discriminator is a model for recognizing a pattern of data and determines whether inputted data is original data or fake data generated from the generator.

Moreover, the generator may be learned by receiving and using data which does not deceive the discriminator, and the discriminator may be learned by receiving and using deceived data generated by the generator. Therefore, the generator may evolve so as to deceive the discriminator as much as possible, and the discriminator may evolve so as to distinguish original data from data generated by the generator.

The AE is a neural network for reproducing an input as an output.

The AE may include an input layer, at least one hidden layer, and an output layer.

In this case, the number of node of the hidden layer may be smaller than the number of nodes of the input layer, and thus, a dimension of data may be reduced, whereby compression or encoding may be performed.

Moreover, data outputted from the hidden layer may enter the output layer. In this case, the number of nodes of the output layer may be larger than the number of nodes of the hidden layer, and thus, a dimension of the data may increase, and thus, decompression or decoding may be performed.

The AE may control the connection strength of a neuron through learning, and thus, input data may be expressed as hidden layer data. In the hidden layer, information may be expressed by using a smaller number of neurons than those of the input layer, and input data being reproduced as an output may denote that the hidden layer detects and expresses a hidden pattern from the input data.

The semi-supervised learning is a kind of machine learning and may denote a learning method which uses both training data with a label assigned thereto and training data with no label assigned thereto.

As a type of semi-supervised learning technique, there is a technique which infers a label of training data with no label assigned thereto and performs learning by using the inferred label, and such a technique may be usefully used for a case where the cost expended in labeling is large.

The reinforcement learning may be a theory where, when an environment where an agent is capable of determining an action to take at every moment is provided, the best way is obtained through experience without data.

The reinforcement learning may be performed by a Markov decision process (MDP).

To describe the MDP, firstly an environment where pieces of information needed for taking a next action of an agent may be provided, secondly an action which is to be taken by the agent in the environment may be defined, thirdly a reward provided based on a good action of the agent and a penalty provided based on a poor action of the agent may be defined, and fourthly an optimal policy may be derived through experience which is repeated until a future reward reaches a highest score.

An artificial neural network may be specified in structure by a configuration of a model, an activation function, a loss function, or a cost function, a learning algorithm, an optimization algorithm, and the like. A hyperparameter may be set in advance before the learning, and then, a model parameter may be set through the learning to specify contents thereof.

For example, factors that determine the structure of the artificial neural network may include the number of hidden layers, the number of hidden nodes included in each of the hidden layers, an input feature vector, a target feature vector, and the like.

The hyperparameter includes various parameters that have to be initially set for learning such as an initial value of the model parameter. Also, the model parameter includes various parameters to be determined through the learning.

For example, the hyperparameter may include an initial weight value between the nodes, an initial bias between the nodes, a mini-batch size, the number of learning repetition, a learning rate, and the like. Also, the model parameter may include a weight between the nods, a bias between the nodes, and the like.

The loss function can be used for an index (reference) for determining optimum model parameters in a training process of an artificial neural network. In an artificial neural network, training means a process of adjusting model parameters to reduce the loss function and the object of training can be considered as determining model parameters that minimize the loss function.

The loss function may mainly use a mean squared error (MSE) or a cross entropy error (CEE), but the present invention is not limited thereto.

The CEE may be used when a correct answer label is one-hot encoded. One-hot encoding is an encoding method for setting a correct answer label value to 1 for only neurons corresponding to a correct answer and setting a correct answer label to 0 for neurons corresponding to a wrong answer.

A learning optimization algorithm may be used to minimize a loss function in machine learning or deep learning, as the learning optimization algorithm, there are Gradient Descent (GD), Stochastic Gradient Descent (SGD), Momentum, NAG (Nesterov Accelerate Gradient), Adagrad, AdaDelta, RMSProp, Adam, and Nadam.

The GD is a technique that adjusts model parameters such that a loss function value decreases in consideration of the gradient of a loss function in the current state.

The direction of adjusting model parameters is referred to as a step direction and the size of adjustment is referred to as a step size.

Here, the step size may mean the learning rate.

In the GD, a gradient may be acquired by partially differentiating the loss function into each of the model parameters, and the model parameters may be updated by changing the model parameters by the learning rate in a direction of the acquired gradient.

The SGD is a technique that increases the frequency of gradient descent by dividing training data into mini-batches and performing the GD for each of the mini-batches.

The Adagrad, AdaDelta, and RMSProp in the SGD are techniques that increase optimization accuracy by adjusting the step size. The momentum and the NAG in the SGD are techniques that increase optimization accuracy by adjusting the step direction. The Adam is a technique that increases optimization accuracy by adjusting the step size and the step direction by combining the momentum and the RMSProp. The Nadam is a technique that increases optimization accuracy by adjusting the step size and the step direction by combining the NAG and the RMSProp.

The learning speed and accuracy of an artificial neural network greatly depends on not only the structure of the artificial neural network and the kind of a learning optimization algorithm, but the hyperparameters. Accordingly, in order to acquire a good trained model, it is important not only to determine a suitable structure of an artificial neural network, but also to set suitable hyperparameters.

In general, hyperparameters are experimentally set to various values to train an artificial neural network, and are set to optimum values that provide stable learning speed and accuracy using training results.

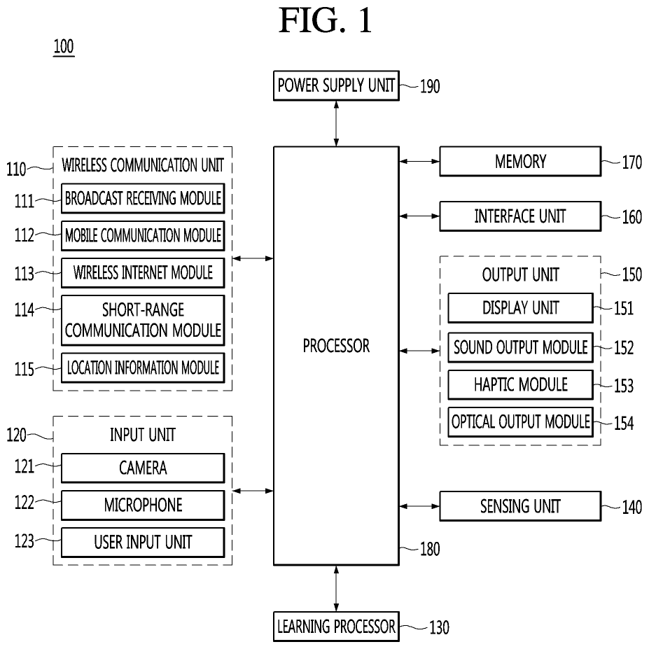

FIG. 1 is a block diagram illustrating a configuration of the terminal 100 according to an embodiment of the present invention.

Hereinafter, the terminal 100 may be called an artificial intelligence (AI) apparatus 100.

The terminal 100 may be implemented for a TV, a projector, a mobile phone, a smart phone, a laptop computer, a digital broadcasting terminal, a personal digital assistant (PDA), a portable multimedia player (PMP) a slate PC, a tablet PC, an ultrabook, a wearable device (for example, a smartwatch, a smart glass, a head mounted display (HMD)), a set-top box (STB), a DMB receiver, a radio, a washing machine, a refrigerator, a desktop computer, fixed equipment such as a digital signage, movable equipment, and the like.

That is, the terminal device 100 may be implemented as various appliances that are used at home, and may be applied to a fixed or movable robot.

The terminal device 100 can perform a function of a voice agent. The voice agent may be a program that recognizes voice of a user and output a response suitable for the recognized user's voice using voice.

Referring to FIG. 1, the terminal 100 may include a wireless communication unit 110, an input unit 120, a learning processor 130, a sensing unit 140, an output unit 150, an interface unit 160, a memory 170, a processor 180, and a power supply unit 190.

The trained model may be mounted on the terminal 100.

The trained model may be implemented as hardware, software, or a combination of the hardware and the software. When a portion or the whole of the trained model is implemented as the software, one or more commands constituting the trained model may be stored in the memory 170.

The wireless communication unit 110 may include at least one of a broadcast receiving module 111, a mobile communication module 112, a wireless Internet module 113, a short-range communication module 114, or a location information module 115.

The broadcast receiving module 111 of the wireless communication unit 110 may receive a broadcast signal and/or broadcast related information from an external broadcast management server through a broadcast channel.

The mobile communication module 112 may transmit/receive a wireless signal to/from at least one of a base station, an external terminal, or a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless Internet module 113 refers to a module for wireless internet access and may be built in or external to the mobile terminal 100. The wireless Internet module 113 may be configured to transmit/receive a wireless signal in a communication network according to wireless internet technologies.

The wireless internet technology may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A) and the wireless internet module 113 transmits/receives data according at least one wireless internet technology including internet technology not listed above.

The short-range communication module 114 may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, or Wireless Universal Serial Bus (USB) technologies.

The location information module 115 is a module for obtaining the location (or the current location) of a mobile terminal and its representative examples include a global positioning system (GPS) module or a Wi-Fi module. For example, the mobile terminal may obtain its position by using a signal transmitted from a GPS satellite through the GPS module.

The input unit 120 may include a camera 121 for image signal input, a microphone 122 for receiving audio signal input, and a user input unit 123 for receiving information from a user.

Voice data or image data collected by the input unit 120 are analyzed and processed as a user's control command.

The input unit 120 may acquire training data for the model learning and input data to be used when an output is acquired using the trained model.

The input unit 120 may acquire input data that is not processed. In this case, the processor 180 or the learning processor 130 may preprocess the acquired data to generate training data that is capable of being inputted into the model learning or preprocessed input data.

Here, the preprocessing for the input data may mean extracting of an input feature from the input data.

Then, the input unit 120 is used for inputting visual information (or signal), audio information (or signal), data, or information inputted from a user and the mobile terminal 100 may include at least one camera 121 in order for inputting visual information.

The camera 121 processes image frames such as a still image or a video obtained by an image sensor in a video call mode or a capturing mode. The processed image frame may be displayed on the display unit 151 or stored in the memory 170.

The microphone 122 processes external sound signals as electrical voice data. The processed voice data may be utilized variously according to a function (or an application program being executed) being performed in the mobile terminal 100. Moreover, various noise canceling algorithms for removing noise occurring during the reception of external sound signals may be implemented in the microphone 122.

The user input unit 123 is to receive information from a user and when information is inputted through the user input unit 123, the processor 180 may control an operation of the mobile terminal 100 to correspond to the inputted information.

The user input unit 123 may include a mechanical input means (or a mechanical key, for example, a button, a dome switch, a jog wheel, and a jog switch at the front, back or side of the mobile terminal 100) and a touch type input means. As one example, a touch type input means may include a virtual key, a soft key, or a visual key, which is displayed on a touch screen through software processing or may include a touch key disposed at a portion other than the touch screen.

The learning processor 130 learns a model composed of the artificial neural network by using the training data.

Particularly, the learning processor 130 may determine optimized model parameters of the artificial neural network by repeatedly learning the artificial neural network by using the above-described various learning techniques.

In this specification, since the artificial neural network is learned by using the training data, the artificial neural network of which the parameters are determined may be called a learned model or a trained model.

Here, the trained model may be used to infer results for new input data rather than training data.

The learning processor 130 may be configured to receive, classify, store, and output information which is to be used for data mining, data analysis, intelligent decision, and machine learning algorithms.

The learning processor 130 may include one or more memory units which are configured to store data received, detected, sensed, generated, pre-defined, or outputted by another component, another device, another terminal, or an apparatus communicating with the terminal.

The learning processor 130 may include a memory which is integrated into or implemented in a terminal. In some embodiments, the learning processor 130 may be implemented with the memory 170.

Optionally or additionally, the learning processor 130 may be implemented with a memory associated with a terminal like an external memory directly coupled to the terminal or a memory which is maintained in a server communicating with the terminal.

In another embodiment, the learning processor 130 may be implemented with a memory maintained in a cloud computing environment or another remote memory position accessible by a terminal through a communication manner such as a network.

The learning processor 130 may be configured to store data in one or more databases, for supervised or unsupervised learning, data mining, prediction analysis, or identifying, indexing, categorizing, manipulating, storing, searching for, and outputting data to be used in another machine. Here, the database may be implemented using a memory 170, a memory 230 of the learning device 200, a memory maintained under cloud computing environments, or other remote memory locations that are accessible by the terminal through a communication scheme such as a network.

Information stored in the learning processor 130 may be used by the processor 180 or one or more other controllers of a terminal by using at least one of various different types of data analysis algorithm or machine learning algorithm.

Examples of such algorithms may include a k-nearest neighbor system, a purge logic (for example, possibility theory), a neural network, Boltzmann machine, vector quantization, a pulse neural network, a support vector machine, a maximum margin classifier, hill climbing, an induction logic system Bayesian network, perrytnet (for example, a finite state machine, a milli machine, and a moor finite state machine), a classifier tree (for example, a perceptron tree, a support vector tree, a Markov tree, a decision tree forest, and an arbitrary forest), a reading model and system, artificial mergence, sensor mergence, image mergence, reinforcement mergence, augment reality, pattern recognition, and automated plan.

The processor 180 may determine or predict at least one executable operation of a terminal, based on information determined or generated by using a data analysis algorithm and a machine learning algorithm. To this end, the processor 180 may request, search for, receive, or use data of the learning processor 130 and may control the terminal to execute a predicted operation or a preferably determined operation of the at least one executable operation.

The processor 180 may perform various functions of implementing an intelligent emulation (i.e., a knowledge-based system, an inference system, and a knowledge acquisition system). The processor 180 may be applied to various types of systems (for example, a purge logic system) including an adaptive system, a machine learning system, and an ANN.

The processor 180 may include a sub-module enabling an arithmetic operation of processing a voice and a natural language voice, like an input/output (I/O) processing module, an environment condition processing module, a speech-to-text (STT) processing module, a natural language processing module, a work flow processing module, and a service processing module.

Each of such sub-modules may access one or more systems or data and models or a subset or superset thereof in a terminal. Also, each of the sub-modules may provide various functions in addition to vocabulary index, user data, a work flow model, a service model, and an automatic speech recognition (ASR) system.

In another embodiment, another aspect of the processor 180 or a terminal may be implemented with the sub-module, system, or data and model.

In some embodiments, based on data of the learning processor 130, the processor 180 may be configured to detect and sense a requirement on the basis of an intention of a user or a context condition expressed as a user input or a natural language input.

The processor 180 may actively derive and obtain information which is needed in completely determining the requirement on the basis of the intention of the user or the context condition. For example, the processor 180 may analyze past data including an input log, an output log, pattern matching, unambiguous words, and an input intention, thereby actively deriving needed for determining the requirement.

The processor 180 may determine task flow for executing a function of responding to the requirement, based on the intention of the user or the context condition.

The processor 180 may be configured to collect, sense, extract, detect, and/or receive a signal or data used for data analysis and a machine learning operation through one or more sensing components in a terminal, for collecting information which is to be processed and stored in the learning processor 130.

Collecting of information may include an operation of sensing information through a sensor, an operation of extracting information stored in the memory 170, or an operation of receiving information through a communication means from another terminal, an entity, or an external storage device.

The processor 180 may collect usage history information from the terminal and may store the collected usage history information in the memory 170.

The processor 180 may determine an optimal match for executing a specific function by using the stored usage history information and prediction modeling.

The processor 180 may receive or sense ambient environmental information or other information through the sensing unit 140.

The processor 180 may receive a broadcast signal and/or broadcast-related information, a wireless signal, and wireless data through the wireless communication unit 110.

The processor 180 may receive visual information (or a corresponding signal), audio information (or a corresponding signal), data, or user input information through the input unit 120.

The processor 180 may collect information in real time and may process or classify the collected information (for example, a knowledge graph, an instruction policy, an individualization database, a dialogue engine, etc.) and may store the processed information in the memory 170 or the learning processor 130.

When an operation of the terminal is determined based on the data analysis algorithm, the machine learning algorithm, and technology, the processor 180 may control elements of the terminal for executing the determined operation. Also, the processor 180 may control the terminal according to a control instruction to perform the determined operation.

When a specific operation is performed, the processor 180 may analyze history information representing execution of the specific operation through the data analysis algorithm, the machine learning algorithm, and technique and may update previously learned information, based on the analyzed information.

Therefore, the processor 180 may enhance an accuracy of a future performance of each of the data analysis algorithm, the machine learning algorithm, and the technique along with the learning processor 130, based on the updated information.

The sensing unit 140 may include at least one sensor for sensing at least one of information in a mobile terminal, environmental information around a mobile terminal, or user information.

For example, the sensing unit 140 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, the camera 121), a microphone (for example, the microphone 122), a battery gauge, an environmental sensor (for example, a barometer, a hygrometer, a thermometer, a radiation sensor, a thermal sensor, and a gas sensor), or a chemical sensor (for example, an electronic nose, a healthcare sensor, and a biometric sensor). Moreover, a mobile terminal disclosed in this specification may combines information sensed by at least two or more sensors among such sensors and may then utilize it.

The output unit 150 is used to generate a visual, auditory, or haptic output and may include at least one of a display unit 151, a sound output module 152, a haptic module 153, or an optical output module 154.

The display unit 151 may display (output) information processed in the mobile terminal 100. For example, the display unit 151 may display execution screen information of an application program running on the mobile terminal 100 or user interface (UI) and graphic user interface (GUI) information according to such execution screen information.

The display unit 151 may be formed with a mutual layer structure with a touch sensor or formed integrally, so that a touch screen may be implemented. Such a touch screen may serve as the user input unit 123 providing an input interface between the mobile terminal 100 and a user, and an output interface between the mobile terminal 100 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user can feel. A representative example of a haptic effect that the haptic module 153 generates is vibration.

The optical output module 154 outputs a signal for notifying event occurrence by using light of a light source of the mobile terminal 100. An example of an event occurring in the mobile terminal 100 includes message reception, call signal reception, missed calls, alarm, schedule notification, e-mail reception, and information reception through an application.

The interface unit 160 may serve as a path to various kinds of external devices connected to the mobile terminal 100. The interface unit 160 may include at least one of a wired/wireless headset port, an external charger port, a wired/wireless data port, a memory card port, a port connecting a device equipped with an identification module, an audio Input/Output (I/O) port, an image I/O port, and or an earphone port. In correspondence to that an external device is connected to the interface unit 160, the mobile terminal 100 may perform an appropriate control relating to the connected external device.

Moreover, the identification module, as a chip storing various information for authenticating usage authority of the mobile terminal 100, may include a user identity module (UIM), a subscriber identity module (SIM), and a universal subscriber identity module (USIM). A device equipped with an identification module (hereinafter referred to as an identification device) may be manufactured in a smart card form. Accordingly, the identification device may be connected to the terminal 100 through the interface unit 160.

The memory 170 may store data for supporting various functions of the terminal 100.

The memory 170 may store a plurality of application programs or applications executed in the terminal 100, pieces of data and instructions for an operation of the terminal 100, and pieces of data (for example, at least one piece of algorithm information for machine learning) for an operation of the learning processor 130.

The memory 170 may store a model that is learned in the learning processor 130 or the learning device 200.

Here, the memory 170 may store the learned model into a plurality of versions according to a learning time point, a learning progress, and the like.

Here, the memory 170 may store the input data acquired by the input unit 120, the learning data (or the training data) used for the model learning, a learning history of the model, and the like.

Here, the input data stored in the memory 170 may be input data itself, which is not processed, as well as data that is processed adequate for the model learning.

The processor 180 may control overall operations of the mobile terminal 100 generally besides an operation relating to the application program. The processor 180 may provide appropriate information or functions to a user or process them by processing signals, data, and information inputted/outputted through the above components or executing application programs stored in the memory 170.

Additionally, in order to execute an application program stored in the memory 170, the processor 180 may control at least part of the components shown in FIG. 1. Furthermore, in order to execute the application program, the processor 180 may combine at least two of the components in the mobile terminal 100 and may then operate it.

As described above, the processor 180 may control an operation associated with an application program and an overall operation of the terminal 100. For example, when a state of the terminal 100 satisfies a predetermined condition, the processor 180 may execute or release a lock state which limits an input of a control command of a user for applications.

The power supply unit 190 may receive external power or internal power under a control of the processor 180 and may then supply power to each component in the mobile terminal 100. The power supply unit 190 includes a battery and the battery may be a built-in battery or a replaceable battery.

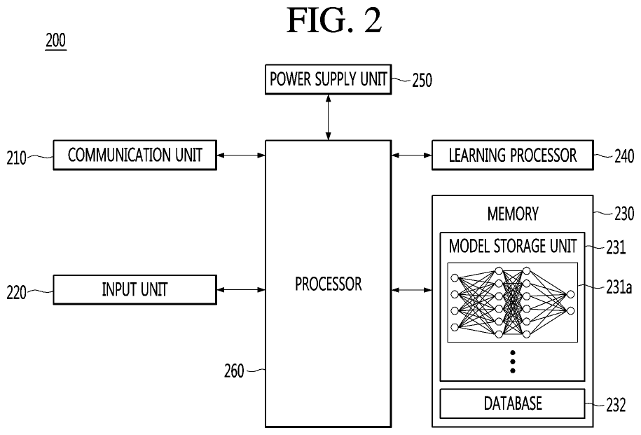

FIG. 2 is a block diagram illustrating a configuration of a learning device 200 of an artificial neural network according to an embodiment of the present invention.

The learning device 200 may be a device or server that is separately provided outside the terminal 100 and perform the same function as the learning processor 130 of the terminal 100.

That is, the learning device 200 may be configured to receive, classify, store, and output information to be used for data mining, data analysis, intelligent decision making, and machine learning algorithm. Here, the machine learning algorithm may include a deep learning algorithm.

The learning device 200 may communicate with at least one terminal 100 and analyze or train the data instead of the terminal 100 or by assisting the terminal 100 to derive results. Here, the assisting for the other devices may mean distribution of computing power through distribution processing.

The learning device 200 for the artificial neural network may be a variety of apparatuses for learning an artificial neural network and may be generally called a server or called a learning device or a learning server.

Particularly, the learning device 200 may be implemented not only as a single server but also as a plurality of server sets, a cloud server, or a combination thereof.

That is, the learning device 200 may be provided in a plurality to constitute the learning device set (or the cloud server). At least one or more learning device 200 included in the learning device set may analyze or train data through the distribution processing to derive the result.

The learning device 200 may transmit the model that is learned by the machine learning or the deep learning to the terminal periodically or by demands.

Referring to FIG. 2, the learning device 200 may include a communication unit 210, an input unit 220, a memory 230, a learning processor 240, a power supply unit 250, a processor 260, and the like.

The communication unit 210 may correspond to a constituent including the wireless communication unit 110 and the interface unit 160 of FIG. 1. That is, the communication unit 210 may transmit and receive data to/from other devices through wired/wireless communication or an interface.

The input unit 220 may be a constituent corresponding to the input unit 120 of FIG. 1 and may acquire data by receiving the data through the communication unit 210.

The input unit 220 may acquire training data for the model learning and input data for acquiring an output by using the trained model.

The input unit 220 may acquire input data that is not processed. In this case, the processor 130 may preprocess the acquired data to generate training data that is capable of being inputted into the model learning or preprocessed input data.

Here, the preprocessing for the input data, which is performed in the input unit 220, may mean extracting of an input feature from the input data.

The memory 230 is a constituent corresponding to the memory 170 of FIG. 1.

The memory 230 may include a model storage unit 231 and a database 232.

The model storage unit 231 may store a model being learned or a learned model (or an artificial neural network 231a) through the learning processor 240 to store the updated model when the model is updated through the learning.

Here, the model storage unit 231 may store the trained model into a plurality of versions according to a learning time point, a learning progress, and the like.

The artificial neural network 231a illustrated in FIG. 2 may be merely an example of the artificial neural network including a plurality of hidden layers, and the artificial neural network of the present invention is not limited thereto.

The artificial neural network 231a may be implemented as hardware, software, or a combination of the hardware and the software. When a portion or the whole of the artificial neural network 231a is implemented as the software, one or more commands constituting the artificial neural network 231a may be stored in the memory 230.

The database 232 may store the input data acquired by the input unit 220, the learning data (or the training data) used for the model learning, a learning history of the model, and the like.

The database 232 stored in the memory 232 may be input data itself, which is not processed, as well as data that is processed adequate for the model learning.

The learning processor 240 is a constituent corresponding to the learning processor 130 of FIG. 1.

The learning processor 240 may train (or learn) the artificial neural network 231a by using the training data or the training set.

The learning processor 240 may directly acquire the processed data of the input data acquired through the input unit 220 to train the artificial neural network 231a or acquire the processed input data stored in the database 232 to train the artificial neural network 231a.

Particularly, the learning processor 240 may determine optimized model parameters of the artificial neural network 231a by repeatedly learning the artificial neural network 231a by using the above-described various learning techniques.

In this specification, since the artificial neural network is learned by using the training data, the artificial neural network of which the parameters are determined may be called a learned model or a trained model.

Here, the trained model may infer a result value in a state in which the trained model is installed on the learning device 200 or may be transmitted to the other device such as the terminal 100 through the communication unit 210 so as to be mounted.

Also, when the trained model is updated, the updated trained model may be transmitted to the other device such as the terminal 100 through the communication unit 210 so as to be mounted.

The power supply unit 250 is a constituent corresponding to the power supply unit 190 of FIG. 1.

Duplicated description with respect to the constituents corresponding to each other will be omitted.

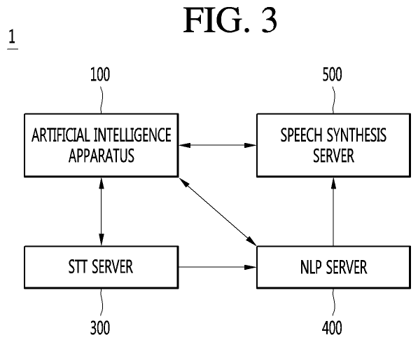

FIG. 3 is a block diagram illustrating an artificial intelligence system 1 according to an embodiment of the present invention.

Referring to FIG. 3, the artificial intelligence system 1 may include an artificial intelligence apparatus 100, a speech to text (STT) server 300, a natural language processing (NLP) server 400, and a speech synthesis server (500).

The artificial intelligence apparatus 100 may transmit speech data to the STT server 300.

The STT server 300 may convert the speech data received from the artificial intelligence apparatus 100 into text data.

The STT server 300 may increase an accuracy of speech-text conversion using a language model.

The language model may mean a model that may calculate a probability of a sentence or calculate a probability of occurrence of the next word when previous words are given.

For example, the language model may include probabilistic language models such as a unigram model, a bigram model, an N-gram model, and the like.

The unigram model is a model that assumes that usages of all words are completely independent of each other. The unigram model calculates a probability of a word sequence as a product of a probability of each word.

The bigram model is a model that assumes that the word usage depends only on a previous one word.

The N-GRAM model assumes that the word usage depends on previous (n−1) words.

That is, the STT server 300 may determine whether the text data converted from the speech data is appropriately converted using the language model, thereby increasing the accuracy of the conversion into the text data.

The NLP server 400 may receive the text data from the STT server 300. The NLP server 400 may perform intention analysis on the text data based on the received text data.

The NLP server 400 may transmit intention analysis information indicating a result of the intention analysis to the terminal 100.

The NLP server 400 may generate the intention analysis information by sequentially performing a morpheme analysis step, a phrase analysis step, a speech act analysis step, and a conversation processing step on the text data.

The morpheme analysis step is a step of classifying the text data corresponding to speech uttered by a user in units of a morpheme, which is the smallest unit having meaning, and of determining which part of speech each classified morpheme has.

The phrase analysis step is a step of classifying the text data into noun phrases, verb phrases, adjective phrases, and the like using a result of the morpheme analysis step and of determining what relations exist between the classified phrases.

Through the phrase analysis step, a subject, an object, and modifiers of the speech uttered by the user may be determined.

The speech act analysis step is a step of analyzing an intention of the speech uttered by the user using the results of the phrase analysis step. Specifically, the speech act analysis step is a step of determining an intention of a sentence, such as whether the user asks a question, makes a request, or expresses a simple emotion.

The conversation processing step is a step of determining whether to answer, respond, or ask for additional information for the user's utterance using the results of the speech act analysis step.

After the conversation processing step, the NLP server 400 may generate the intention analysis information including at least one of the answer, respond, ask for the additional information for the intention of the user utterance.

In one example, the NLP server 400 may receive text data from the terminal 100. For example, when the terminal 100 supports a speech to text function, the terminal 100 may convert the speech data into the text data and transmit the converted text data to the NLP server 400.

The speech synthesis server 500 may combine pre-stored speech data with each other to generate a synthesized speech.

The speech synthesis server 500 may record speech of one person selected as a model and divide the recorded speech in units of syllables or words. The speech synthesis server 500 may store the speech divided in units of the syllables or words in an internal or external database.

The speech synthesis server 500 may search for syllables or words corresponding to given text data from the data base and synthesize searched syllables or words into a combination to generate a synthesized speech.

The speech synthesis server 500 may store a plurality of speech language groups corresponding to each of a plurality of languages.

For example, the speech synthesis server 500 may include a first speech language group recorded in Korean and a second speech language group recorded in English.

The speech synthesis server 500 may translate text data of a first language into text of a second language and generate a synthesized speech corresponding to a text of the translated second language using the second speech language group.

The speech synthesis server 500 may transmit the generated synthesized speech to the artificial intelligence apparatus 100.

The speech synthesis server 500 may receive the intention analysis information from the NLP server 400.

The speech synthesis server 500 may generate a synthesized speech reflecting the intention of the user based on the intention analysis information.

In one embodiment, the STT server 300, the NLP server 400, and the speech synthesis server 500 may be implemented as one server. For example, the STT server 300, the NLP server 400, and the speech synthesis server 500 may constitute one learning server 200.

Alternatively, the STT server 300, the NLP server 400, and the speech synthesis server 500 may use trained models or engines in the learning server 200.

Each of functions of the STT server 300, the NLP server 400, and the speech synthesis server 500 described above may also be performed in the artificial intelligence apparatus 100. To this end, the artificial intelligence apparatus 100 may include a plurality of processors.

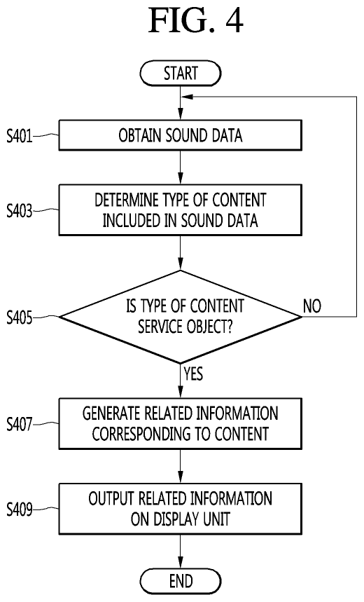

FIG. 4 is a flowchart illustrating a method for providing visual information according to an embodiment of the present invention.

Referring to FIG. 4, the processor 180 of the artificial intelligence apparatus 100 obtains sound data (S401).

The processor 180 may obtain sound data via the microphone 122 of the input unit 120.

The processor 180 may obtain sound data from an external terminal (not shown) via the wireless communication unit 110. In this case, the sound data may be obtained by a microphone (not shown) provided in the external terminal (not shown).

The sound data obtained from the external terminal (not shown) may have various sound data formats. For example, the sound data formats include way, mp3, and the like.

The sound data may include sound output from a media playback device including a TV, a radio, or the like.

The sound data may include speech based on a user's utterance.

The speech based on the user's utterance may refer to an utterance including a command for controlling the artificial intelligence apparatus 100, a query for searching for information, and the like.

When a preset wake-up voice is input, the processor 180 may obtain the sound data including the speech based on the user's utterance.

Here, the artificial intelligence apparatus 100 may be composed of an artificial intelligence speaker that functions as a hub of an artificial intelligence platform, of an artificial intelligence radio with a radio function, and of a sound playback device or a sound bar of the media playback device such as the TV.

The processor 180 of the artificial intelligence apparatus 100 determines a type of content included in the sound data (S403).

The processor 180 may obtain sound data from which noise is removed by pre-processing for identifying the content included in the sound data. Alternatively, the processor 180 may obtain the sound data from which the noise is removed by pre-processing after identifying the content included in the sound data.

Here, the processor 180 may remove the noise only if the type of the content included in the sound data is not music. This is because, if the noise is removed for the music, an accuracy of music recognition may be lowered.

The processor 180 may generate the sound data from which the noise is removed using a noise canceling engine or a noise canceling filter directly, or transmit the sound data to the learning apparatus 200 and receive the sound data from which the noise is removed.

The sound data from which the noise is removed via the pre-processing may be adjusted in volume to be suitable for the artificial intelligence apparatus 100. In other words, volume control may be seen as a part of the pre-processing process.

Hereinafter, sound data may refer to the sound data from which the noise is removed via the pre-processing.

The processor 180 may first determine whether the type of the content included in the sound data is the music and determine the type of the content based on content of the speech included in the sound data if it is determined that the content is not the music.

Alternatively, the processor 180 may determine the type of the content based on the content of the speech included in the sound data and determine whether the type of the content is the music if the type of the content is not determined.

Alternatively, the processor 180 may determine the type of the content based on the speech included in the sound data and music included in the sound data.

When the type of the content is determined based on the content of the speech included in the sound data, the processor 180 may use the sound data from which the noise is removed.

That is, the processor 180 determines whether the type of the content is the music using the sound data from which the noise is not removed, extracts the content of the speech using the sound data from which the noise is removed if it is determined that the content is not the music, and determines the type of the content based on the content of the speech.

The processor 180 may use a music recognition function to determine whether the music is included in the sound data.

The processor 180 may obtain program information about at least one of the TV or the radio to determine the type of the content, determine whether the sound data is sound data for a TV program or a radio program using the obtained program information, and determine the type of the content by determining which broadcast program is included in the sound data.

Here, the program information may mean an electronic program guide (EPG).

Here, the processor 180 may determine whether the sound data is output from the TV or the radio based on whether the sound data is received from the TV or the radio. If it is determined that the sound data is output from the TV or the radio, the program information for at least one of the TV or the radio may be obtained.

The processor 180 may receive the program information provided by the TV or the radio via the wireless communication unit 110 or may obtain information about a program of the TV or the radio from an Internet.

The program information provided by the TV or the radio may mean the EPG.

The information about the program of the TV or the radio obtained from the Internet may mean the EPG but may also mean information including a program type, a program timetable, and the like of the TV or the radio.

The content of the speech included in the sound data may be extracted as a keyword.

In addition, the content of the speech included in the sound data may mean intention information about the speech included in the sound data.

The processor 180 may directly extract the content of the speech included in the sound data.

Here, the processor 180 may extract the content of the speech included in the sound data or the intention information about the speech using at least one of an STT engine or a natural language processing engine received by the learning device 200.

The processor 180 may obtain the content of the speech included in the sound data or the intention information about the speech using the learning device 200.

Here, the processor 180 may convert the sound data into a text using the STT engine stored in the memory 170, transmit the converted text to the learning device 200, and receive the content of the speech or the intention information about the speech generated by the learning device 200 from the converted text using the natural language processing engine.

Here, the processor 180 may transmit the obtained sound data to the learning device 200 and receive the content of the speech or the intention information about the speech generated by the learning device 200 using at least one of the STT engine or the natural language engine.

The processor 180 of the artificial intelligence apparatus 100 determines whether the determined type of the content is a service object (S405).

In an embodiment of the present invention, the artificial intelligence apparatus 100 provides a service for obtaining the sound data and generating and providing related information corresponding to the content included in the obtained sound data. Accordingly, the processor 180 may determine the type of the content included in the sound data and then determine whether the type of the content is the object of the service of providing the related information.

The processor 180 may determine that all types of the content are the service objects, determine, using a whitelist, that only types of the content listed in a whitelist are the service objects, or determine, using a blacklist, that types of the content not listed in the blacklist are the service objects.

Here, the type of content that is the service object may include at least one of a command, news, music, or shopping broadcast.

The command may refer to an utterance for the user to control or interact with the artificial intelligence apparatus 100.

The news or shopping broadcast may mean that the broadcast program of the TV or the radio is the news or shopping broadcast.

The music may refer to music included in the broadcast program of the TV or the radio, or music input to the artificial intelligence apparatus 100.

The types of the content included in the sound data may be a plurality of types.

For example, even in a case of the shopping broadcast, if a background music is included, the processor 180 may determine the type of the content as the shopping broadcast and the music.

That is, the type of the content may mean a tag for identifying and distinguishing the content.

As a result of the determination in S405, if the type of the content is not the service object, the processor 180 returns to S401 of obtaining the sound data again.

Here, the processor 180 may selectively output, to the display unit 151, information indicating that the type of the content is not the service object.

As a result of the determination in S405, if the type of the content is the service object, the processor 180 generates the related information corresponding to the content (S407).

Here, the processor 180 may determine an item to be included in the related information based on the type of the content.

If the type of the content is the command, the processor 180 may generate a response corresponding to the corresponding command as the related information.

For example, if the command is a command for requesting weather, the processor 180 may generate weather information as the related information.

For example, if the command is a command for asking a schedule of the user, the processor 180 may generate schedule information of the user as the related information.

If the type of the content is the news, the processor 180 may generate related news of the corresponding news as the related information. In this case, the item to be included in the related information may include the related news.

If the type of the content is the shopping broadcast, the processor 180 may generate at least one of a name, specification information, price information, or similar product information of a product sold in the shopping broadcast as the related information. In this case, the item to be included in the related information may include at least one of the name, specification information, price information, or similar product information of the product.

If the type of the content is the music, the processor 180 may generate at least one of a title, an artist, an album name, an album release date, or lyrics of the corresponding music as the related information. In this case, the item to be included in the related information may include at least one of the title, the artist, the album name, the album release date, or the lyrics of the music.

Here, if the related information includes the lyrics of the music, the processor 180 may match a progress of the music included in the obtained sound data to a progress of the lyrics of the music and allow only lyrics corresponding to the matched progress to be included in the related information.

The processor 180 may obtain the program information of the TV or the radio and generate the obtained program information as the related information.

For example, if it is determined that a program A of the TV is currently being watched from the obtained sound data, the processor 180 may generate program information about the program A or EPG as the related information.

If there are the plurality of the content types, the processor 180 may generate all related information corresponding to respective content.

For example, if the sound data is sound data about the shopping broadcast including the background music, the processor 180 may generate related information including at least one of an EPG about the shopping broadcast, information on the background music, or information on the product sold in the shopping broadcast.

The processor 180 outputs, on the display unit 151, the generated related information (S409).

If the generated related information is too much to be output to the display unit 151 at once, the processor 180 may divide the generated related information and output the information on a plurality of pages.

If the generated related information is composed of information that may be classified into different categories, the processor 180 may output information belonging to the different categories on different pages.

For example, if music currently playing is input as the sound data, the processor 180 may determine the type of the content as the music, and generate the music title, the artist, the album information, the lyrics, and the like as the related information. In this case, the processor 180 may output music information including the music title and the artist on a page 1, the album information on a page 2, and the lyrics on a page 3 via the display unit 151.

Information to be included in each page may be variously set based on user's selection.

In the example above, the music title and the artist are included on the same page. However, music information page and an artist information page may be classified based on the user's selection or the lyrics may be included in the music information page.

When the processor 180 outputs, on the display unit 151, the related information on a plurality of pages, the processor 180 may output, on the display 151, an indication indicating a position of each page together.

For example, if the related information is output on three pages, the processor 180 may indicate which page among the total three pages is each page.

Here, the indication indicating the position of each page may indicate a current page number and a total page number or may be indicated as a mark for identifying the total pages and the current page position.

If the related information is divided on the plurality of pages, the processor 180 may set a title or a keyword indicating page content for each page. The title or the keyword may be or may not be output to the display unit 151.

The title or the keyword indicating the page content may be used to specify a specific page among the plurality of pages in place of the page number.

For example, it is assumed that the type of the content included in the sound data is the music, and the processor 180 divides, as the related information, the artist information, the lyrics information, and the album information about the corresponding music on separate pages, respectively. In this case, the processor 180 may set a title or a keyword for a page including the artist information as an “artist” or an “artist information”, a title or a keyword for a page including the lyrics information as a “lyrics” or a “lyrics Information”, and a title or a keyword for a page including the album information as an “album” or an “album information”.

If the related information is output on a plurality of pages on the display unit 151, the user may change a page output on the display unit 151 by uttering a speech.

Here, the user may utter a page number to be displayed on the display unit 151 or a title or a keyword for content of the page to be displayed. Then, the processor 180 may specify a page to be displayed using the page number or the title or the keyword for the page content included in the utterance of the user and output the specified page to the display unit 151.

For example, the user may utter, such as “page 2” or “show the page 2” to change the page about the related information output on the display unit 151 to the page 2. Alternatively, the user may utter, such as “lyrics information” or “show lyrics information” to change the page about the related information output on the display unit 151 to a page displaying the lyrics information.

If the display unit 151 is implemented as a touch screen that may involve input, the processor 180 may change a page outputting the related information based on a gesture input to the touch screen.

In one embodiment, if the processor 180 does not identify the type of the content included in the sound data or determines that the type of the content is not the service object, the processor 180 may output information set as a default value to the display unit 151.

For example, if a type of specific content is not identified or the type of the specific content is determined not to be the service object in the sound data, the processor 180 may output at least one of the weather information, time information, or schedule information set as the default value to the display unit 151.

Although not shown in FIG. 3, the processor 180 may convert the related information or a guidance corresponding thereto into a speech using a text to speech (TTS) engine and output the converted speech via the audio output unit 152 or the speaker.

For example, if sound data including a command of the user is obtained and a response corresponding to the command is generated as the related information, the processor 180 may convert all or a portion of the related information into a speech while outputting the related information to the display unit 151 to output the speech via the sound output unit 152 or the speaker.

Alternatively, the processor 180 may output only a guidance indicating that the related information is provided via the sound output unit 152 or the speaker while outputting the generated related information to the display unit 151.

The method for providing the visual information illustrated in FIG. 4 illustrates a process of obtaining the sound data at one time point and outputting the related information. The method for providing the visual information illustrated in FIG. 4 may be continuously or repeatedly performed to provide the visual information for the sound data input in real time.

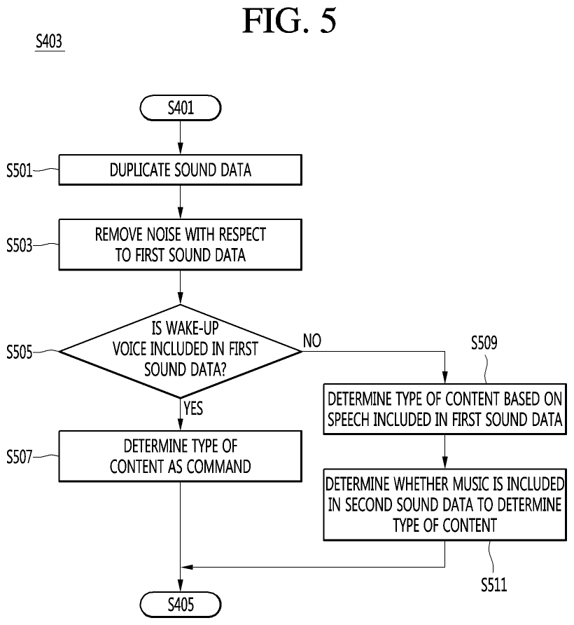

FIG. 5 is a flowchart illustrating an example of a step S403 of determining a type of content included in sound data illustrated in FIG. 4.

Referring to FIG. 5, the processor 180 duplicates the obtained sound data into two copies (S501).

Here, the duplicated sound data may be respectively referred to as first sound data and second sound data.

The first sound data may be used to recognize the speech included in the sound data by removing the noise.

The second sound data may be used to recognize the music included in the sound data without removing the noise. This is because when the noise is removed, sound in a frequency band excluding the speech is determined as the noise and removed, and thus the music may be distorted.

The processor 180 removes the noise with respect to the first sound data (S503).

As described above, the first sound data may mean sound data from which the noise is to be removed among the two duplicated sound data.

The processor 180 may remove the noise with respect to the first sound data using the noise canceling engine or the noise canceling filter.

The noise canceling engine or the noise canceling filter may be implemented as an artificial neural network and learned from the learning device 200.

The processor 180 may receive the noise canceling engine from the learning device 200 and may remove the noise with respect to the first sound data using the received noise canceling engine.

The processor 180 may transmit the first sound data to the learning device 200 and receive the first sound data from which the noise is removed from the learning device 200. Here, the learning device 200 may remove the noise using the noise canceling engine learned for the received first sound data and transmit the first sound data from which the noise is removed to the artificial intelligence apparatus 100.

The processor 180 determines whether a wake-up voice is included in the first sound data from which the noise is removed (S505).

The wake-up voice may refer to a preset phrase for initiating an interaction via the speech of the user in the artificial intelligence apparatus 100.

For example, the wake-up voice may be “Hi LG.”.

If the sound data includes the wake-up voice for the user to interact with the artificial intelligence apparatus 100 in speech, the wake-up voice is also included in the first sound data from which the noise is removed.

As a result of the determination in S505, if the wake-up voice is included in the first sound data from which the noise is removed, the processor 180 determines the type of the content as the command (S507).

That is, the processor 180 may first determine whether the command of the user is included in the sound data in the determining of the type of the content.

As a result of the determination in S505, if the wake-up voice is not included in the first sound data from which the noise is removed, the processor 180 determines the type of the content based on the speech included in the first sound data from which the noise is removed (S509).

Since it is already determined that the wake-up voice is not included in the first sound data from which the noise is removed, the command is excluded from the type of the content determined in S509.

As described above, the processor 180 may determine whether the type of the content is the news, the shopping broadcast, or the like, based on the speech included in the first sound data from which the noise is removed.

However, the processor 180 may fail to determine the type of the content based on the speech such as in a case in which only the music is included in the sound data. In this case, if the processor 180 fails to determine the appropriate type of the content, the processor 180 may proceed to a next step without determining the type of the content.

Further, the processor 180 may determine whether the music is included in the second sound data from which the noise is not removed to determine the type of the content (S511). As described above, the second sound data may refer to sound data from which the noise will not be removed among the two duplicated sound data.

Even when the type of the content is determined in S509, if it is determined that the music is included in the second sound data in S511, the processor 180 may add the music to the type of the content that is already determined.

That is, a plurality of content types may be determined.

FIG. 4 discloses the method for determining the type of the content by duplicating the sound data, but this is merely an example.

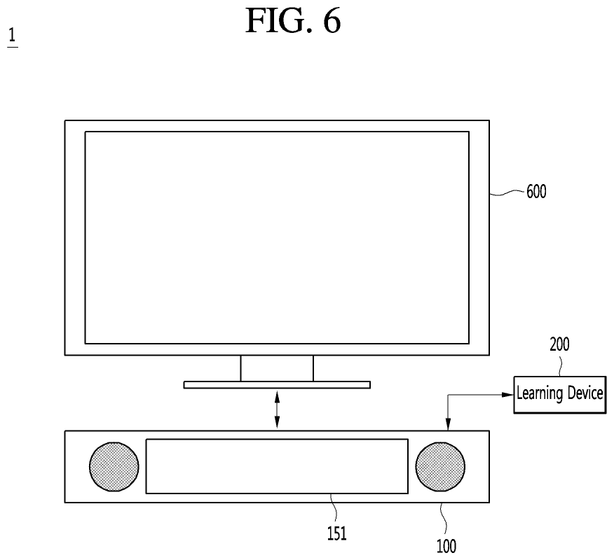

FIG. 6 is a view illustrating the artificial intelligence system 1 according to an embodiment of the present invention.

Referring to FIG. 6, the artificial intelligence system 1 according to an embodiment of the present invention may include the artificial intelligence apparatus 100, the learning device 200, and a TV 600 according to an embodiment of the present invention.

The artificial intelligence apparatus 100, which may be implemented in a form of the sound bar functioning as the sound output device, includes the display unit 151.

Here, the artificial intelligence apparatus 100 may be installed adjacent to the TV 600 within a predetermined distance in order to obtain a sound output from the TV 600 better, but the present invention is not limited thereto.

The artificial intelligence apparatus 100 may obtain the sound output from the TV 600 as the sound data directly via the microphone 122 or receive sound data corresponding to a sound signal to be output from the TV 600 from the TV 600 or the external device (not shown) via the wireless communication unit 110.

If the artificial intelligence apparatus 100 operates as a device for outputting sound on behalf of the TV 600, it may be considered that the artificial intelligence apparatus 100 receives, from the TV 600, the sound data corresponding to the sound signal output from the TV 600.

If the artificial intelligence apparatus 100 does not operate as the device for outputting the sound on behalf of the TV 600, the artificial intelligence apparatus 100 may obtain the sound output from the TV 600 as the sound data via the microphone 122 or may receive the sound data corresponding to the sound signal to be output from the TV 600 via the TV 600 or the external device (not shown).

The learning device 200 may train the STT engine, the natural language processing engine, the noise canceling engine, and the like using a machine learning algorithm or a deep learning algorithm.

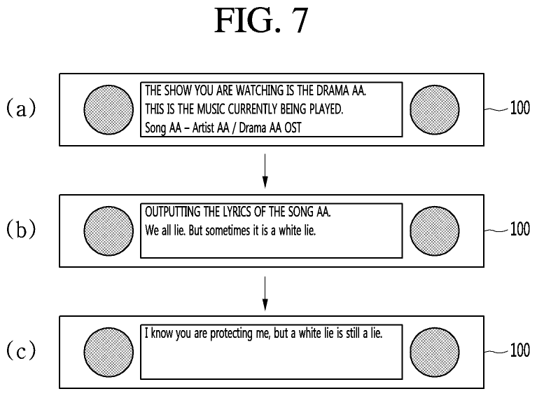

FIGS. 7 to 9 are views illustrating examples of providing visual information by the artificial intelligence apparatus 100 according to an embodiment of the present invention.

Specifically, FIGS. 7 to 9 assume that the TV is playing a drama called a “Drama AA”, and a background music is included in the drama at the present playback time point. Here, an artist of the background music is an “artist AA” and a title thereof is a “Song AA”.

Referring to FIG. 7, the artificial intelligence apparatus 100 according to an embodiment of the present invention may provide information about the drama being played on the TV and the music included in the drama.

The processor 180 may obtain sound data for the drama being played on the TV, analyze the sound data, and determine that the type of the content is the drama and the music.

The processor 180 may include the title of the drama being played, the title of the music, the artist, the album information, lyrics information, and the like as related information corresponding to the content included in the sound data and may output the generated information via the display unit 151.

Here, the processor 180 may output the related information in time series as shown in (a), (b), and (c) in FIG. 7.

For example, the processor 180 may output, on the display unit 151, “The show you are watching is the “Drama AA”. This is the music currently being played. Song AA—Artist AA/Drama AA OST″ ((a) in FIG. 7), “Outputting the lyrics of the Song AA. We all lie. But sometimes it is a white lie.” ((b) in FIG. 7), and “I know you are protecting me, but a white lie is still a lie.” ((c) in FIG. 7).

If the lyrics of the music is output, the processor 180 may correspond the progress of the lyrics to the progress of the music currently being played, and output the lyrics in accordance with the corresponding progress.

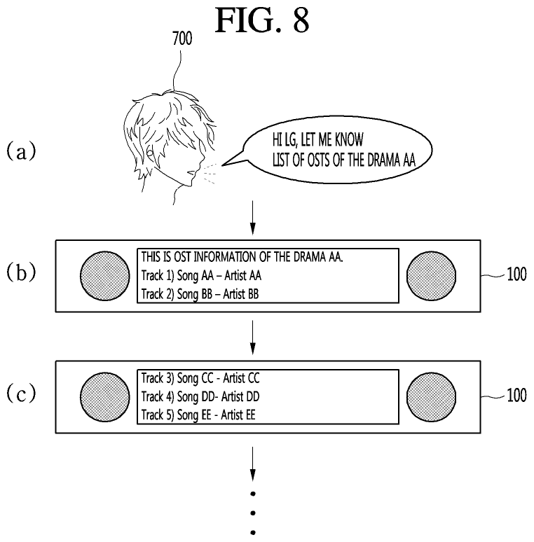

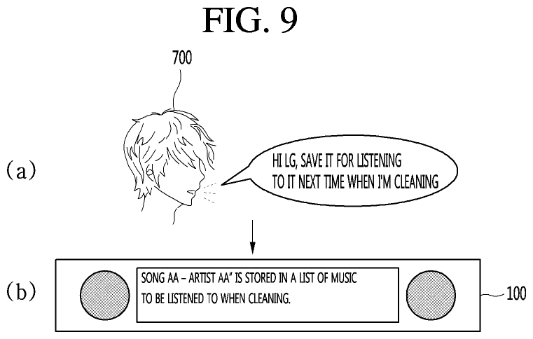

Referring to FIGS. 8 and 9, the artificial intelligence apparatus 100 according to an embodiment of the present invention may recognize a command of a user 700 to perform an operation corresponding thereto or provide a response as related information.

For example, when the user 700 uttered, “Hi LG, let me know a list of OSTs of the Drama AA” ((a) in FIG. 8), the processor 180 may recognize that it is a command for requesting the OST list of the drama “Drama AA” from the utterance included in the obtained sound data, generate the OST list of the “Drama AA” as related information in response thereto, and provide the generated OST list ((b) and (c) in FIG. 8). Here, the “Hi LG.” is an example of the wake-up voice of the artificial intelligence apparatus 100.

Alternatively, for example, when the user 700 uttered “Hi LG, save it for listening to it next time when I'm cleaning.” ((a) in FIG. 9), the processor 180 may recognize that it is a command for storing the “Song AA—Artist AA”, which is the music currently being played, in a “list of music to be listened to when cleaning” from the utterance included in the obtained sound data, add the “Song AA—Artist AA” in the “list of music to be listened to when cleaning” accordingly, and provide the operation result as related information ((b) in FIG. 9). Here, the “Hi LG.” is an example of the wake-up voice of the artificial intelligence apparatus 100.

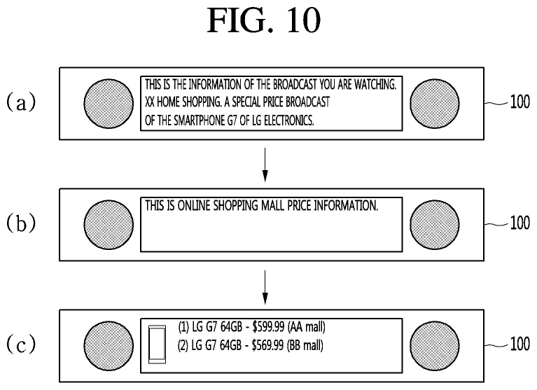

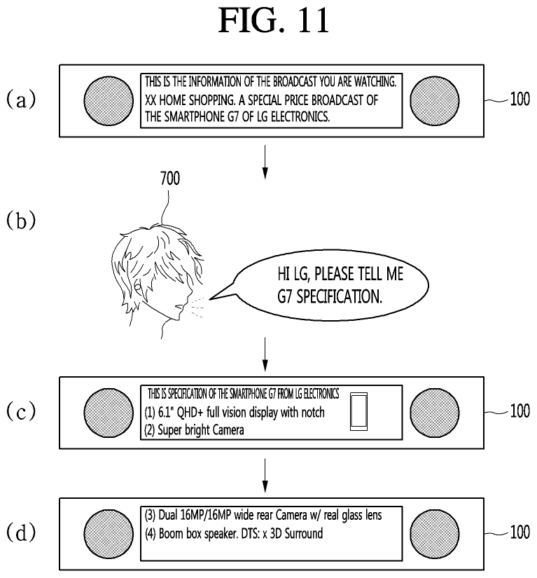

FIGS. 10 and 11 are views illustrating examples of providing visual information by the artificial intelligence apparatus 100 according to an embodiment of the present invention.

Specifically, FIGS. 10 and 11 assume that the TV is playing a XX home shopping broadcast, and a home shopping product is a smartphone G7™ of LG Electronics™.

Referring to FIG. 10, the artificial intelligence apparatus 100 according to an embodiment of the present invention may provide information about the shopping broadcast being played on the TV, price information of the product sold in the shopping broadcast, or the like.

The processor 180 may obtain sound data for the shopping broadcast being played on the TV, analyze the sound data, and determine that the type of the content is the shopping broadcast.

The processor 180 may include the information of the shopping broadcast being played, a name of the product being sold, detailed information, price information, related product information, and the like as related information corresponding to the content included in the sound data and output the generated information via the display unit 151.

Here, the processor 180 may output the related information in time series as shown in (a), (b) and (c) in FIG. 10.

For example, the processor 180 may output, on the display unit 151, “This is the information of the broadcast you are watching. XX Home Shopping. A special price broadcast of the smartphone G7 of LG electronics” ((a) in FIG. 10), “This is online shopping mall price information.” ((b) in FIG. 10), and “(1) LG G7 64 GB—$599.99 (AA mall). (2) LG G7 64 GB—$569.99 (BB mall).” together with images for identifying products ((c) in FIG. 10).

The processor 180 may search for a price of a product to be sold in at least one online shopping mall and provide the searched price information.

If it is determined that there is an online shopping mall preferred by the user, the processor 180 may include, in the searched price information, price information searched in the online shopping mall preferred by the user and provide the searched price information.

The processor 180 may determine the preferred online shopping mall based on user's online shopping mall account information, purchase history, or the like.

For example, the processor 180 may determine that an online shopping mall in which the user's account information exists is the preferred online shopping mall or may determine an online shopping mall having a recent purchase history as the preferred online shopping mall.

Referring to FIG. 11, the artificial intelligence apparatus 100 according to an embodiment of the present invention may recognize the command of the user 700 to perform an operation corresponding thereto or provide a response as the related information.

For example, the processor 180 may output, on the display unit 151,]“This is the information of the broadcast you are watching. XX Home Shopping. A special price broadcast of the smartphone G7 of LG electronics” ((a) in FIG. 11). When the user 700 uttered “Hi LG, please tell me a G7 specification.” ((b) in FIG. 11), the processor 180 may recognize that it is a command for providing a specification of the smartphone G7™ from LG Electronics™ from the utterance included in the obtained sound data, obtain the specification information of the smartphone G7™ and generate the specification information of the smartphone G7™ as the related information in response thereto, and provide the generated related information ((c) and (d) in FIG. 11). Here, the “Hi LG.” is an example of the wake-up voice of the artificial intelligence apparatus 100.

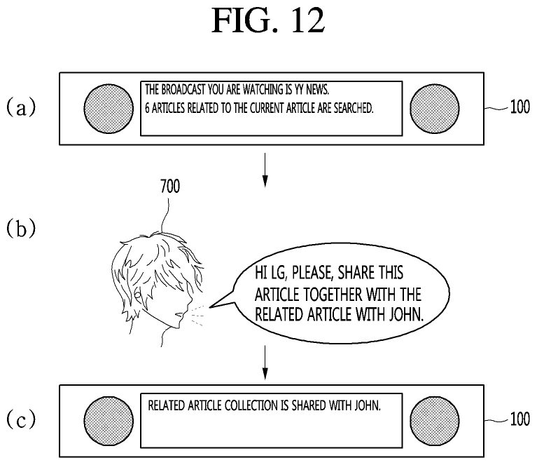

FIG. 12 is a view illustrating an example of providing visual information by the artificial intelligence apparatus 100 according to an embodiment of the present invention.

Specifically, FIG. 12 assumes that the news is being played on the TV.

Referring to FIG. 12, the artificial intelligence apparatus 100 according to an embodiment of the present invention may provide program information, current article information, related article information, and the like of the news being played on the TV. In addition, the command of the user 700 may be recognized and a response corresponding to the command may be provided as the related information.

The processor 180 may obtain sound data of the news being played on the TV and analyze the sound data to determine that the type of the content is the news.

The processor 180 may include the program information, the current article information, the related article information, and the like of the news being played as the related information corresponding to content included in the sound data and output the generated information via the display unit 151.

For example, the processor 180 may output, to the display unit 151, “The broadcast you are watching is YY News. 6 articles related to the current article are searched.” ((a) in FIG. 12). When the user 700 uttered, “Hi LG, please, share this article together with the related article with John.” ((b) in FIG. 12), the processor 180 may recognize that it is a command to share a related article collection including content of the current article and the retrieved six related articles from the utterance included in the obtained sound data, to a person named John, share the related article collection with John in response thereto, and output the result ((c) in FIG. 12). Here, the “Hi LG.” is an example of the wake-up voice of the artificial intelligence apparatus 100.

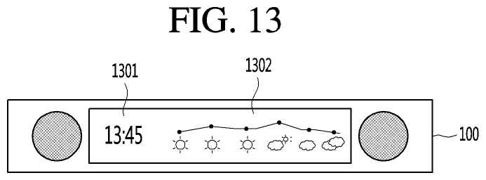

FIG. 13 is a view illustrating an example of providing visual information by the artificial intelligence apparatus 100 according to an embodiment of the present invention.

Referring to FIG. 13, the artificial intelligence apparatus 100 according to an embodiment of the present invention may provide time information, weather information, or the like as related information by the command of the user 700 or when in a standby state.

That is, when the sound data is not input, if it is determined that the content is not included even when the sound data is input, or if the type of the content is determined not to be the service object, the processor 180 may provide time information 1301, weather information 1302, or the like as the related information. In this standby state, the content of the information to be provided as the related information may be changed by user setting.

The processor 180 may provide the time information, the weather information, and the like as the related information even when there is a request of the user 700.

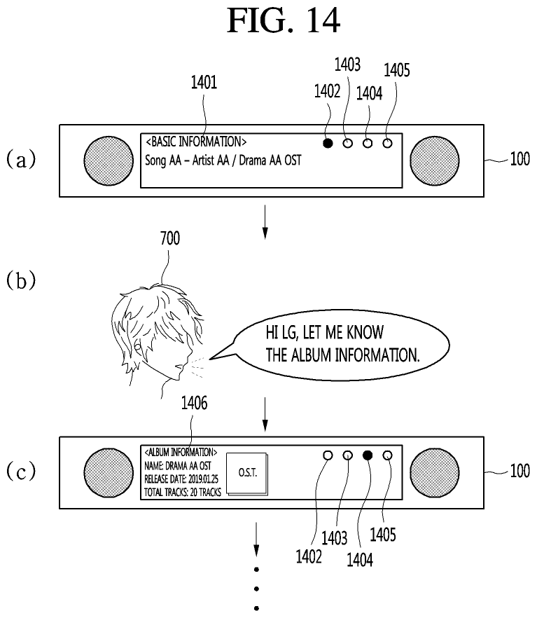

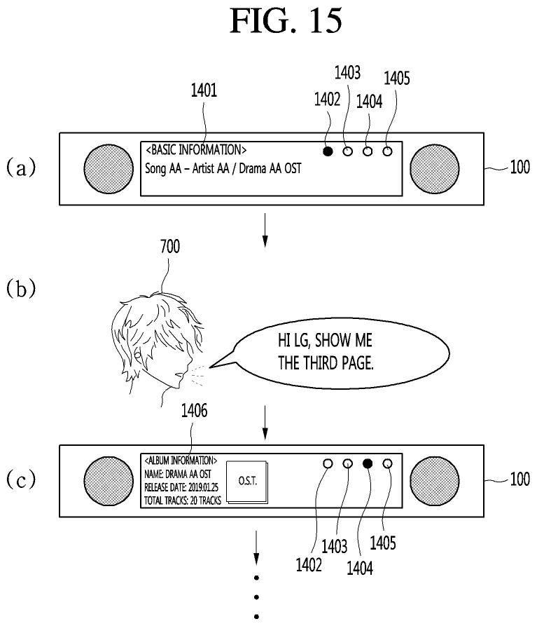

FIGS. 14 and 15 are views illustrating examples of providing visual information by the artificial intelligence apparatus 100 according to an embodiment of the present invention.

Referring to FIGS. 14 and 15, the artificial intelligence apparatus 100 according to an embodiment of the present invention may output related information corresponding to music included in sound data to the display unit 151. Further, the related information may include basic information, artist information, album information, lyrics information, and the like.

The processor 180 may classify the related information into a plurality of categories and output the classified related information on pages classified into the plurality of categories, respectively.

Each page may be identified through a title or tag corresponding to content of each category.

The processor 180 may output marks 1402 to 1405 indicating a current page or titles or tags 1401 and 1406 corresponding to the current page to distinguish each page.

For example, if sound data corresponding to the song “Song AA” by the artist “Artist AA” in the “Drama AA OST” album, the processor 180 may generate “Song AA—Artist AA/Drama AA OST” representing the title, artist, and album as related information corresponding to the basic information category and output the related information corresponding to the basic information category together with the title or tag 1401 for indicating that the current page corresponds to the basic information category ((a) in FIG. 14 and (a) in FIG. 15).

Here, the processor 180 may output the related information corresponding to the basic information category on one page and may output the title or tag 1401 or 1406 for indicating that the current page corresponds to the basic information category. Similarly, the marks 1402 to 1405 indicating that the current page is a first page among total four pages may be output together. For example, a first page 1402 may correspond to the basic information category, a second page 1403 may correspond to the artist information category, the third page 1404 may correspond to the album information category, and the fourth page 1405 may correspond to the lyrics information category.

As shown in FIG. 14, when the user 700 uttered a command for requesting the album information, such as “Hi LG, let me know the album information.” ((b) in FIG. 14), the processor 180 may change the page from the first page 1402 that was output to the third page 1405 including the related information corresponding to the artist information category ((c) in FIG. 14).

As shown in FIG. 15, when the user 700 uttered a command for requesting the album information, such as “Hi LG, show me the third page.” ((b) in FIG. 15), the processor 180 may change the page from the first page 1402 that was output to the third page 1405 including the related information corresponding to the artist information category ((c) in FIG. 15).

In particular, the processor 180 may identify a preferred related information category based on user's setting or in view of a user's usage history and may output a page corresponding to the preferred related information category preferentially.

For example, in the above example, when a frequency of identifying, by the user 700, the album information was the most frequent when the relation information about the music is provided, the processor 180 may determine the album information category as the preferred related information category in the related information about the music. Further, in the future, when the related information for the music is provided for the user, the processor 180 may output a page including the album information category preferentially.

Here, the related information category preferred by the user 700 may be explicitly set.

The processor 180 may determine a related information category having the highest request frequency as the preferred related information category or may determine a related information category, which is most recently requested, as the preferred related information category.

Further, the processor 180 may assign a higher weight to a recently requested related information category to determine the related information category in consideration of not only a request frequency but also a request time point.

For example, in providing the related information about the music, even though the user 700 had requested the album information category the most synthetically, but it is determined that the user 700 recently requested the lyrics information category more than the album information category, the album information category may be assigned a low weight, and accordingly, the processor 180 may determine the lyrics information category as the preferred related information category.

As such, the artificial intelligence apparatus 100 according to various embodiments of the present invention obtains the sound data and generates the related information corresponding thereto and outputs the related information as the visual information, so that the user may obtain much various information beyond the information that may be obtained only by the sound. The artificial intelligence apparatus 100 may recognize the sound output from the media playback device such as the TV or the radio, and output the information related thereto as the visual information.

For example, the artificial intelligence apparatus 100 may recognize the music output from the TV or the radio and output the information related to the corresponding music. In particular, the lyrics of the music may be output and the lyrics may be output in accordance with the progress of the music.

In addition, the artificial intelligence apparatus 100 may recognize the speech output from the TV or the radio to provide the related additional information.

For example, the artificial intelligence apparatus 100 may recognize the speech of the home shopping broadcast, identify the product to be sold based on the recognized speech, and output the information about the identified product to be sold, the related product information, or the like.

Similarly, the artificial intelligence apparatus 100 may recognize the speech of the news, identify the news content based on the recognized speech, and obtain and output the related news information based on the identified news content.

In addition, the artificial intelligence apparatus 100 may function as the hub of the artificial intelligence platform to be used as the artificial intelligence speaker.

The artificial intelligence speakers or artificial intelligence hubs on the market today are mainly for the speech services and require installation, which is heavily influenced by space and aesthetics. However, since the artificial intelligence apparatus 100 according to various embodiments of the present invention may be implemented as the sound bar having the display, the artificial intelligence apparatus 100 may be installed under a wall or the TV so as not to harm the interior design.

In addition, since the artificial intelligence apparatus 100 according to various embodiments of the present invention may provide various visual information via the display, the artificial intelligence apparatus 100 may provide a wider range of information than the artificial intelligence hub providing only the speech information and may increase a user convenience.

According to an embodiment of the present invention, the above-described method may be implemented as a processor-readable code in a medium where a program is recorded. Examples of a processor-readable medium may include hard disk drive (HDD), solid state drive (SSD), silicon disk drive (SDD), read-only memory (ROM), random access memory (RAM), CD-ROM, a magnetic tape, a floppy disk, and an optical data storage device.

What is claimed is:

1. An artificial intelligence apparatus for providing visual information, the artificial intelligence apparatus comprising:
a display unit; and
a processor configured to:
obtain sound data;
determine a type of content included in the obtained sound data;
generate related information corresponding to the content based on the content and the type of the content; and
output, on the display unit, the generated related information.

2. The artificial intelligence apparatus of claim 1, wherein the processor is configured to:
determine at least one item to be included in the related information based on the type of the content; and
generate the related information based on the determined at least one item.

3. The artificial intelligence apparatus of claim 2, wherein the processor is configured to:
determine whether the sound data is output from a TV or a radio;
obtain program information of the TV or the radio if it is determined that the sound data is a sound output from the TV or the radio; and
generate the related information using the obtained program information.

4. The artificial intelligence apparatus of claim 3, wherein the processor is configured to:
obtain an electronic program guide (EPG) of the TV or the radio; and
generate the related information using the EPG.

5. The artificial intelligence apparatus of claim 2, wherein the processor is configured to:
classify information included in the related information into at least one category; and
output each classified information on each page corresponding to each category,
wherein the page includes an indication indicating a position of a current page relative to total pages, or title or tag information for identifying the category corresponding to the current page.

6. The artificial intelligence apparatus of claim 5, wherein the processor is configured to:
determine a user preference category among the at least one category; and
preferentially output a page corresponding to the user preference category when outputting the related information,
wherein the user preference category is a category having a highest preference score, where the preference score is higher as a user output request frequency is higher and is lower as a time duration between a current time and a user output request timing is longer.

7. The artificial intelligence apparatus of claim 2, wherein the processor is configured to:
if the type of the content is music, determine the item including at least one of a title, an artist, an album name, an album release date, or lyrics of the music; and
generate the related information including the determined item.

8. The artificial intelligence apparatus of claim 7, wherein the processor is configured to:
if the related information includes the lyrics of the music, match a progress of the music included in the obtained sound data to a progress of the lyrics of the music; and
output, on the display unit, the lyrics of the music in accordance with the matched progress.

9. The artificial intelligence apparatus of claim 2, wherein the processor is configured to:
if the type of the content is a shopping broadcast, determine the item, including at least one of a name, specification information, price information, or similar product information of a product sold in the shopping broadcast; and
generate the related information including the determined item.

10. The artificial intelligence apparatus of claim 2, wherein the processor is configured to:
if the type of the content is news, determine the item including related articles of the news; and
generate the related information including the determined item.

11. The artificial intelligence apparatus of claim 1, wherein the processor is configured to:
convert the sound data into a text using a speech to text (STT) engine; and
determine the type of the content in the converted text using a natural language processing engine,
wherein at least one of the STT engine or the natural language processing engine is learned using a machine learning algorithm or a deep learning algorithm.

12. The artificial intelligence apparatus of claim 11, wherein the processor is configured to:
if a command of a user is included in the sound data, determine the type of the content as a command;
obtain intention information corresponding to the sound data using the natural language processing engine; and
generate a response of the intention information as the related information.

13. A method for providing visual information, the method comprising:
obtaining sound data;
determining a type of content included in the obtained sound data;
generating related information corresponding to the content based on the content and the type of the content; and
outputting, on a display unit, the generated related information.

14. A storage medium having a program stored therein, wherein the program is configured for performing a method for providing visual information, the method comprising:
obtaining sound data;
determining a type of content included in the obtained sound data;
generating related information corresponding to the content based on the content and the type of the content; and
outputting, on a display unit, the generated related information.
